(19) United States
(12) Patent Application Publication
(10) Pub. No.: US 2012/0085943 A1
(43) Pub. Date: Apr. 12, 2012

(54) Personal Genital Privacy Shield

(76) Inventor: Peter Spagnuolo, Brooklyn, NY (US)

(21) Appl. No.: 12/899,368

(22) Filed: Oct. 6, 2010

(51) Int. Cl. G21F 3/02

(52) U.S. Cl. 250/516.1

(57) ABSTRACT

A protective sheet to be worn to protect genitalia of the user may include a first layer to cooperate with an underwear of the user, a second layer to cooperate with the first layer, and a third layer to cooperate with the second layer. The second layer may reflect x-rays from a scanning machine, and the first layer may include a soft fabric material. The third layer may include a soft fabric material, and the second layer may include a metallic material. The metallic material may include a metallic film, and the magnetic material may include a metallic foil. The protective sheet may include a pouch to cooperate with the genitalia.

### FIELD OF THE INVENTION

The present invention relates to radiation shields and more particularly to a radiation shield for protecting the genital areas of both men and women.

### BACKGROUND

Adam and Eve were the first humans to desire to cover their gentalia area with a material or other covering to prevent others from viewing the gentalia area. For many years, the gentalia area has been held to be an area that was generally off-limits to other individuals.

Recently, terrorists have attempted to smuggle explosives onto airplanes with the intent of setting off the explosives once the airplane is airborne. In order to combat this threat to airplanes, safety personnel have used metal detectors in order to detect metal parts that could be used to aid in the activation of the explosives. However, technology has permitted these metal parts to be replaced with non metal parts that will not be detected with a metal detector.

Physical pat downs of some individuals have been used in order to detect explosives which may have been placed underneath clothing. However, most individuals will not allow the pat down to be extended to the gentalia area.

In order to accommodate the offensive nature of a patdown in the gentalia area, whole body screening devices have been developed which permit a camera image to develop and image of the individual without his/her clothes obstructing the view. This has raised concerns that the operators of these cameras will be able to view the gentalia area without the express permission of the person being subjected to the body screening device.

### SUMMARY

A protective sheet to be worn to protect genitalia of the user may include a first layer to cooperate with an underwear of the user, a second layer to cooperate with the first layer, and a third layer to cooperate with the second layer.

The second layer may reflect x-rays from a scanning machine, and the first layer may include a soft fabric material.

The third layer may include a soft fabric material, and the second layer may include a metallic material.

The metallic material may include a metallic film, and the magnetic material may include a metallic foil.

The protective sheet may include a pouch to cooperate with the genitalia.

### BRIEF DESCRIPTION OF THE DRAWINGS

The invention may be understood by reference to the following description taken in conjunction with the accompanying drawings, in which, like reference numerals identify like elements, and in which:

FIG. 1 illustrates a front view of the protective sheet positioned within male briefs;

FIG. 2 illustrates a side view of the protective sheet and the male briefs;

FIG. 3 illustrates a front view of the protective sheet of the present invention;

FIG. 4 illustrates a side view of the protective sheet of the present invention;

FIG. 5 illustrates a front view of the protective sheet and a woman's briefs;

FIG. 6 illustrates a side view of the protective sheet and the woman's briefs;

FIG. 7 illustrates a back view of the woman's briefs;

FIG. 8 illustrates a front view of the protective sheet of the present invention.

FIG. 9 illustrates a side view of the protective sheet of the present invention.

### DETAILED DESCRIPTION

It would be desirable for individuals to carry a personal item that would obstruct the view of the screening devices over the gentile area but allow the screening device to work as intended on other areas outside of the gentile area.

The present invention provides a rigid or flexible sheet which may be strategically positioned to cooperate with underwear of the user or may include fastening devices to facilitate the positioning of the rigid or flexible sheet over the gentalia area of the individual. The sheet may be expandable in order to accommodate the anatomy especially males.

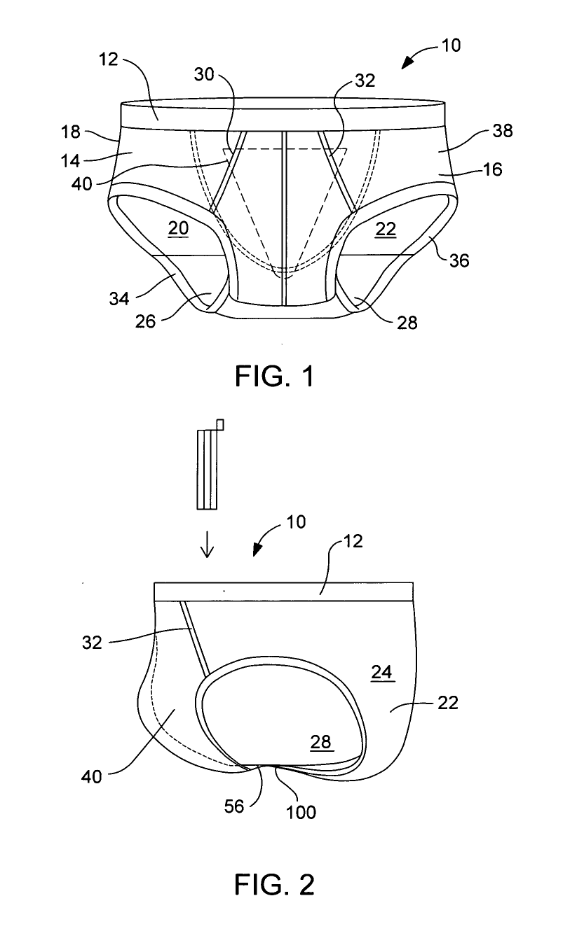

FIGS. 1 and 2 illustrate a pair of male underwear 10 is in the form of a pair of briefs and includes a pair of briefs 38, provided with a protective sheet 40 for preventing the whole body scanning machines from viewing the male genitalia. The briefs 38 may include an elastic waistband 12 which may extend around the lower torso of the wearer. The waistband may include a front segment, a pair of opposed hip-encircling segments and a rear segment. The waistband 12 has a front, facing outwardly, and an inside, facing towards the center. The length of the waistband 12 when fully extended defines the waist of the wearer while the height of the waistband 12 may correspond to the number of inches that the waistband “sits” on the wearer's waist, extending in the direction of the wearer's height. Generally, the elastic waistband 12 has a height of about ½ of an inch to about 2 inches. The underwear 10 may include a front cloth section 14 extending across the front and covering the male genitalia and extending from one hip to the other hip of the wearer—a pair of opposed, hip covering areas 16 and 18. The underwear 10 also may include a bottom section; and a pair of adjacent, buttocks covering areas 20 and 22. The bottom of the briefs typically provide a covering for the area extending between the leg openings and from rear to front, from the anus of the intended wearer to about where the rear point of attachment of the scrotum is to the lower torso, i.e., the bottom of the briefs 38 basically covers the perineum. Typically, the buttocks covering areas are a smooth, continuous piece of fabric and, indeed, the hip covering areas, 16 and 18 are a continuation of the rear section 24. The front cloth section 14 or panel is typically provided with a front, slanted passageway or aperture (not shown) for providing access by the wearer to his penis, for facilitating urination while maintaining the underwear on the torso.

A pair of opposed, separated leg openings, 26 and 28 may be provided, too, with a pair of men's underwear or briefs. The teachings of the present invention are applicable to briefs or boxers. Thus, for example, the connecting and supporting struts 30 and 32 of the front panel, the elasticity of the waistband 12, the smooth edges 34 and 36 for the leg openings, and the manner of connecting by sewing, if needed, all of the components may be included with the briefs 38.

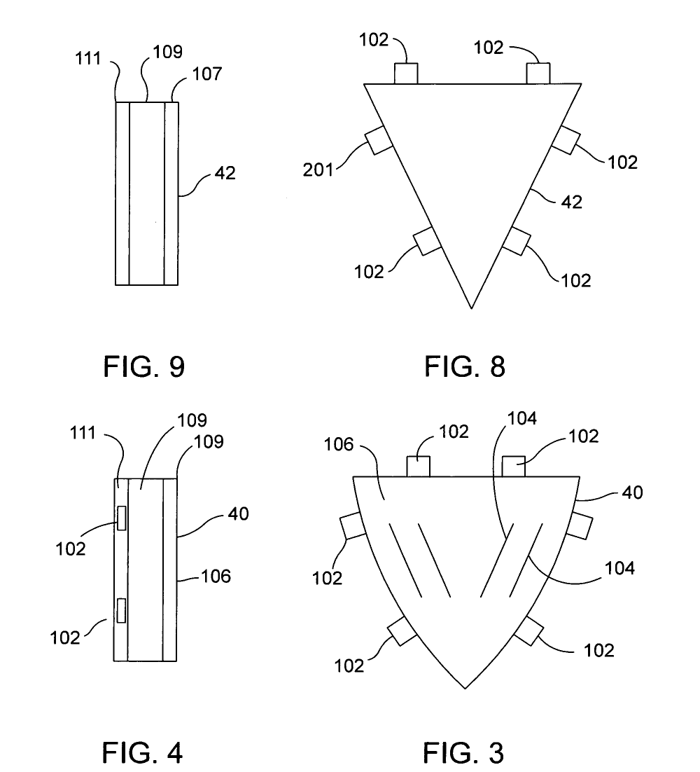

FIG. 3 illustrates a front view of the protective sheet 40 which may be a substantial triangular shaped sheet or may be an oval, rectangle or other shape sheet and which may include a multitude of fastening devices 102 or tabs which may be connected to the periphery of the protective sheet 40. These fastening devices 102 may be formed from fabric and may include and removable adhesive in order to form a detachable connection to the user. The fastening device 102 may include a removable cover (not shown) to protect the removable adhesive before use by the user.

FIG. 3 additionally illustrates an expansion fold 104 to allow the protective sheet 402 expand outwards from the front surface 106 of the protective sheet 40 to take into consideration male genitalia. The expansion fold 104 allows the protective sheet 40 to form a pouch for the male genitalia.

FIG. 4 illustrates a side view of the protective sheet 40 which may include a first layer 107, a second layer 109, and a third layer 111. The first layer 107 may be formed from fabric which may be a soft fabric such as cotton or other appropriate material or may be formed from a nonwoven, mount-blown, dry-laid fabric such as polyethylene or polypropylene to form a shaped covering for the gender of area. The third layer 111 may be a mirror layer of the first layer 107 and second layer 109 may be a layer of metallic foil or metallic film which may be laminated between the first layer 107 and the third layer 111. The first layer 107, the second layer 109 and the third layer 111 may be connected or joined by heating, gluing, ultrasonic welding or other types of fastening.

The protective sheet 40 may be slipped between the underwear 10 and the user as illustrated in FIG. 2. The protective sheet may block millimeter-wave or backscatter x-ray devices in the area protected by the protective sheet 42 by scrambling or concealing the reflected image that may be returned to the imagery devices which may use reflected terahertz and sub terahertz imaging technology. One such device may be the 1.3 Pro vision and other scanning imaging devices.

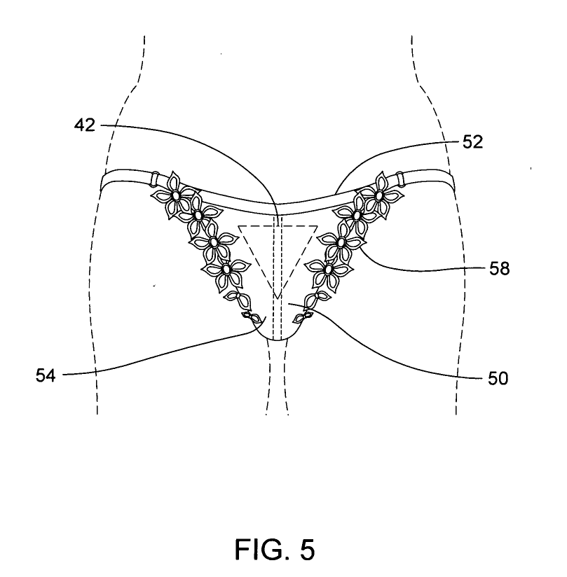

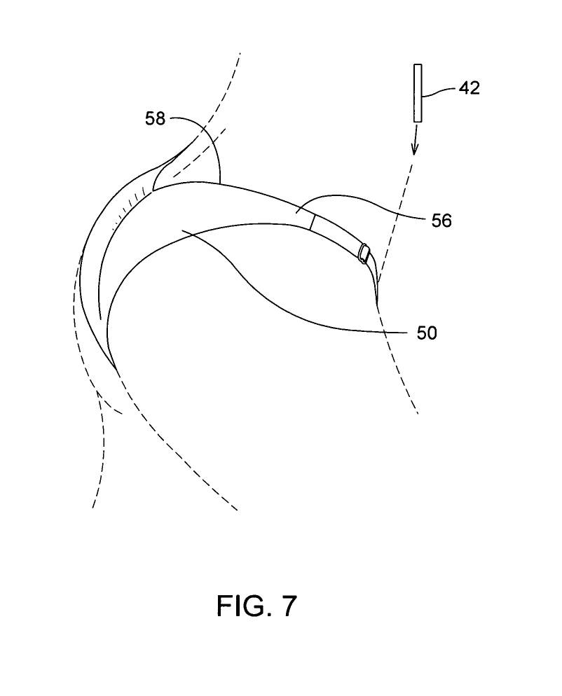

FIGS. 5, 6 and 7 illustrate a pair of female underwear 50 is in the form of a pair of briefs and includes a pair of briefs 58, provided with a protective sheet 42 for preventing the whole body scanning machines from viewing the male genitalia. The briefs 58 may include an elastic waistband 52 which may extend around the lower torso of the wearer. The waistband 52 may include a front segment, a pair of opposed hip-encircling segments and a rear segment. The waistband 52 has a front, facing outwardly, and an inside, facing towards the center. The length of the waistband 52 when fully extended defines the waist of the wearer while the height of the waistband 52 may correspond to the number of inches that the waistband “sits” on the wearer's waist, extending in the direction of the wearer's height. Generally, the elastic waistband 12 has a height of about ½ of an inch to about 2 inches. The underwear 50 may include a front cloth section 54 extending across the front and covering the female genitalia and extending from one hip to the other hip of the wearer—a pair of opposed, hip covering areas 56. The underwear 50 also may include a bottom section; and a pair of adjacent, buttocks covering areas 51 and 53. Typically, the buttocks covering areas are a smooth, continuous piece of fabric and, indeed, the hip covering areas, 56 and 58 are a continuation of the rear section 54.

FIG. 5 illustrates a front view of the protective sheet 40 which may be a substantial triangular shaped sheet or may be an oval, rectangle or other shape sheet and which may include a multitude of fastening devices 102 or tabs which may be connected to the periphery of the protective sheet 42. These fastening devices 102 may be formed from fabric and may include a removable adhesive in order to form a detachable connection to the user. The fastening device 102 may include a removable sheet (not shown) to protect the removable adhesive before use by the user.

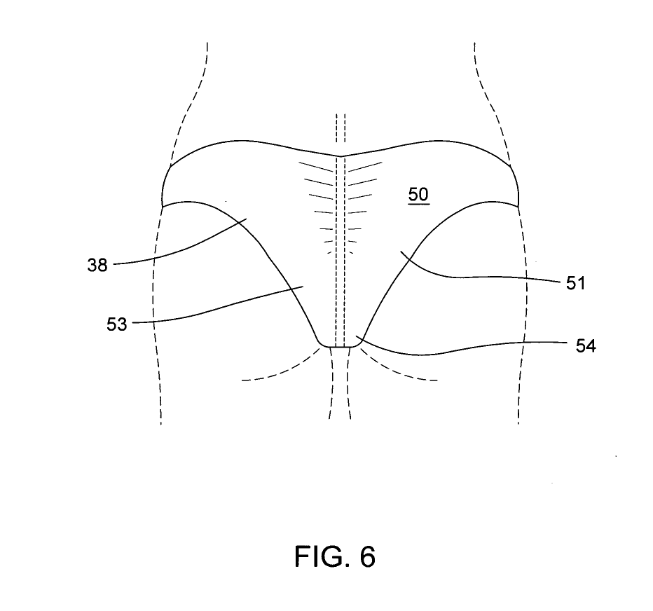

FIG. 6 illustrates a side view of the protective sheet 42 which may include a first layer 107, a second layer 109, and a third layer 111. The first layer 107 may be formed from fabric which may be a soft fabric such as cotton or other appropriate material or may be formed from a nonwoven, mount-blown, dry-laid fabric such as polyethylene or polypropylene to form a shaped covering for the gender of area. The third layer 111 may be a mirror layer of the first layer 107 and second layer 109 may be a layer of metallic foil or metallic film which may be laminated between the first layer 107 and the third layer 111. The first layer 107, the second layer 109 and the third layer 111 may be connected or joined by heating, gluing, ultrasonic welding or other types of fastening.

The protective sheet 42 may be slipped between the underwear 10 and the user as illustrated in FIG. 5. Alternatively, the protective sheet 40, 42 may be used without underwear, being held in position by the fastening devices 102 which may be a tab with removable adhesive. The protective sheet may block millimeter-wave or backscatter x-ray devices in the area protected by the protective sheet 42 by scrambling or concealing the reflected image that may be returned to the imagery devices which may use reflected terahertz and sub terahertz imaging technology. One such device may be the 1.3 Pro vision and other scanning imaging devices.

FIG. 8 illustrates a front view of the protective sheet of the present invention.

FIG. 9 illustrates a side view of the protective sheet of the present invention.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

1. A protective sheet to be worn to protect genitalia of the user, comprising:
a first layer to cooperate with an underwear of the user;
a second layer to cooperate with the first layer;
a third layer to cooperate with the second layer;
wherein the second layer reflects x-rays from a scanning machine.

2. A protective sheet to be worn to protect genitalia of the user as in claim 1, wherein the first layer includes a soft fabric material.

3. A protective sheet to be worn to protect genitalia of the user as in claim 1, wherein the third layer includes a soft fabric material.

4. A protective sheet to be worn to protect genitalia of the user as in claim 1, wherein the second layer includes a metallic material.

5. A protective sheet to be worn to protect genitalia of the user as in claim 4, wherein the metallic material includes a metallic film.

6. A protective sheet to be worn to protect genitalia of the user as in claim 4, wherein the metallic material includes a metallic foil.

7. A protective sheet to be worn to protect genitalia of the user as in claim 1, wherein the protective sheet includes a pouch to cooperate with the genitalia.

8. A protective sheet to be worn to protect genitalia of the user as in claim 1, wherein the protective sheet includes an expansion fold.
